(19) United States
(12) Patent Application Publication
(10) Pub. No.: US 2018/0139597 A1
(43) Pub. Date: May 17, 2018

(54) Socially Enabled, Body Worn Communication Device and Method for Use

(71) Applicants: Jean-Paul Labrosse, Altadena, CA (US); Scott Sullivan, San Francisco, CA (US)

(72) Inventors: Jean-Paul Labrosse, Altadena, CA (US); Scott Sullivan, San Francisco, CA (US)

(21) Appl. No.: 15/811,584

(22) Filed: Nov. 13, 2017

Related U.S. Application Data
(60) Provisional application No. 62/421,868, filed on Nov. 14, 2016.

(51) Int. Cl. H04W 4/80; H04W 8/00; H04B 5/00

(52) U.S. Cl. CPC H04W 4/80; G01P 15/00; H04B 5/0031; H04W 8/005

(57) ABSTRACT

A way to exchange contact information between two people in a quick, easy and fun way is provided. Each user wears a bracelet that includes an embedded communication circuit and a bracelet-to-bracelet proximity sensor. When two bracelets are positioned within an inch or so, the proximity sensor of each bracelet will detect the presence of the other bracelet and will then activate the communication circuit to both transmit and receive an ID code to each respective bracelet. Each received code will be stored in onboard memory and can later be retrieved and used to initiate a more formal connection where more personal contact information (e.g., email addresses, cell phone numbers, etc.) may be selectively and safely exchanged, as desired.

In one embodiment, each bracelet includes a magnet and a magnetic field detector. When two bracelets are close to each other or touching each other, each bracelet will detect the magnetic fields of the other bracelet, which will cause the exchange of information between bracelets.

According to another embodiment, each bracelet includes an accelerometer and a microphone and associated control circuitry so that should two users decide to exchange contact information, each will create a common gesture (such as a ‘high-five” slap) and simultaneously shout out a predetermined selected audible word, phrase or sound (such as: “alright” or “great”). Once confirmed, the communication circuit of each bracelet will transmit and receive contact information. Both these embodiments and others are described in greater detail below.

### CLAIM OF PRIORITY

This Application claims priority from U.S. Provisional Patent Application No. 62/421,868, filed Nov. 14, 2016, entitled: “Socially-Enabled, Body Worn Communication Device and Method for Use,” the contents of which are incorporated herein in their entirety.

### BACKGROUND OF THE INVENTION

### a) Field of the Invention

This invention generally relates to body-worn communication devices and methods to use them, and more particularly, to such devices that allow for quick and accurate transfer of electronic data between two people.

### b) Description of the Prior Art

Recent advances in technology have changed the ways we live our lives. Today, in the United States, essentially everyone over 16 years old owns and carries with them at all times a smart phone. This compact communication device allows a person to instantly call, email, or text a distant friend, or many people simultaneously, using just a few buttons. They also have full access to the Internet and instant access to a variety of information, such as stocks, contacts, email, texts, the weather, shopping, music, news, etc.

With all its advantages at reaching people, perhaps ironically, the smart phone is not very useful when meeting people in certain social venues, such as at a nightclub, a party, a sports game, or a music concert. These venues are typically crowded, loud, sometimes very dark and sometimes very bright (e.g., a sports stadium). These extreme conditions often make it difficult for a person to even use a smart phone and when they try, they may likely disrupt others in their vicinity.

Normally, when a person first meets another person and wants to exchange contact information, they can just give each other a business card, or they can input cell phone numbers. However, in a noisy, crowded, sometimes dark environment, the exchange of information becomes difficult. In one of the above venues, if they try to connect by exchanging phone numbers on their cell phones, the excessive noise and darkness would likely only frustrate the effort.

WO 2015094220 A1, entitled: “Gesture-based information exchange between devices in proximity” of Schorsch, et al. discloses a system for initiating the exchange of contact information using recognizable gestures, such as high-fives or handshakes. In use, this system will identify motions that are indicative of a greeting event and will then transfer contact information to each party using NFC or Bluetooth®. Applicants of the present application hereby incorporate by this reference, the content of WO 2015094220 A1 in its entirety, as if it were reprinted here.

Applicant has discovered a need to provide a communication device and a system that allows two people to exchange contact information in a secure and easy manner, regardless of the environmental conditions or venue.

It is therefore an object of the invention to provide a communication device that overcomes the deficiencies of the prior art.

It is another object of the invention to provide a communication device that conserves battery power and allows two people to exchange contact information in a secure and easy manner, regardless of the environmental conditions or venue.

### SUMMARY OF THE INVENTION

A way to exchange contact information between two people in a quick, easy and fun way is provided. Each user wears a bracelet that includes an embedded communication circuit and a bracelet-to-bracelet proximity sensor. When two bracelets are positioned within an inch or so, the proximity sensor of each bracelet will detect the presence of the other bracelet and will then activate the communication circuit to both transmit and receive an ID code to each respective bracelet. Each received code will be stored in onboard memory and can later be retrieved and used to initiate a more formal connection where more personal contact information (e.g., email addresses, cell phone numbers, etc.) may be selectively and safely exchanged, as desired.

In one embodiment, each bracelet includes a magnet and a magnetic field detector. When two bracelets are close to each other, each bracelet will detect the magnetic fields of the other bracelet, which will cause the exchange of information between bracelets.

According to another embodiment, each bracelet includes an accelerometer and a microphone and associated control circuitry so that should two users decide to exchange contact information, each will create a common gesture (such as a ‘high-five” slap) and simultaneously shout out a predetermined selected audible word, phrase or sound (such as: “alright” or “great”). Once confirmed, the communication circuit of each bracelet will transmit and receive contact information. Both these embodiments and others are described in greater detail below.

### BRIEF DESCRIPTION OF THE DRAWING FIGURES

FIG. 1 is a perspective view of a communication bracelet, according to a first embodiment of the invention, showing a body and a band;

FIG. 2 is a perspective exploded view of the communication bracelet of FIG. 1, showing details of an embedded circuit module and magnet, according to the first embodiment of the invention;

FIG. 3 is a perspective view of two communication bracelets, of FIG. 1, positioned in close proximity to exchange ID information, according to the first embodiment of the invention;

FIG. 4 is a front view of the bracelets of FIG. 3, showing IR communication exchanging data, according to another embodiment of the invention;

FIG. 5 is a perspective view of the circuit module of FIG. 2, showing details thereof, according to the present invention;

FIG. 6 is a block schematic showing the components of the circuit module of FIG. 5, according to the present invention; and

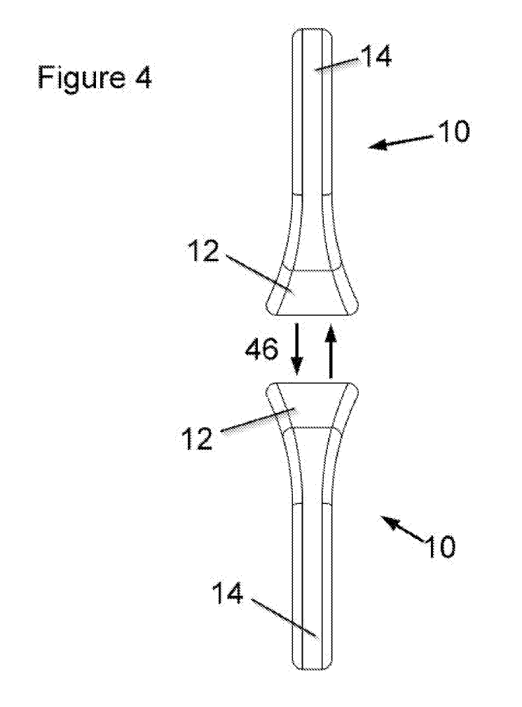

FIG. 7 is an operational flow schematic of the circuit module of FIG. 5, according to the present invention.

### DETAILED DESCRIPTION OF THE PREFERRED EMBODIMENTS

By way of overview, the present invention provides a way to exchange contact information between two people in a quick, easy and fun way. According to a first embodiment of the invention, each user wears a bracelet that includes an embedded communication circuit and a bracelet-to-bracelet proximity sensor. When two bracelets are positioned within an inch or, in some cases, placed in direct physical contact with each other, the proximity sensor of each bracelet will detect the presence of the other bracelet and will then activate the communication circuit to both transmit and receive an ID code to each respective bracelet. Each received code will be stored in onboard memory and can later be retrieved and used to initiate a more formal connection where more personal contact information (e.g., email addresses, cell phone numbers, etc.) may be selectively and safely exchanged, as desired. The types of proximity sensors contemplated include magnetic-based proximity sensors, capacitive sensor, direct electrical contact wherein accessible electrical contacts of each bracelet are effectively connected to each other, use of an infrared emitter and receiver pair, use of a visible emitter receiver pair, use of sound wherein both users must voice a prescribed signature phrase or password to initiate data transmission and use of accelerometers and magnets, wherein the acceleration signature of two magnets (one in each bracelet) being pulled together is detected and used to initiate data exchange.

The bracelet format is used as an example to explain preferred embodiments of the invention. Other wearable devices that users can attach to their person or clothing may also be used with the present invention, including a watch, a ring, a necklace, or any other jewelry item; an item of eyewear (e.g., eyeglasses); a headband; a belt, a shoe, a scarf a vest, or any other article of clothing; and so on. In some instances, a wearable device can have a clip, clasp, or other attachment structure that facilitates attachment of the device to the user's clothing. Also, regardless of the format, the present invention may be used in any of many venues and environments, including sporting events, night clubs, parties, concerts, and while exercising—essentially anywhere two people can meet.

According to another embodiment, each bracelet includes an accelerometer and a microphone and associated control circuitry so that should two users decide to exchange contact information, each will create a common gesture (such as a ‘high-five” slap) and simultaneously shout out a predetermined selected audible word, phrase or sound (such as: “alright” or “great”). Once confirmed, the communication circuit of each bracelet will transmit and receive contact information. Both these embodiments and others are described in greater detail below.

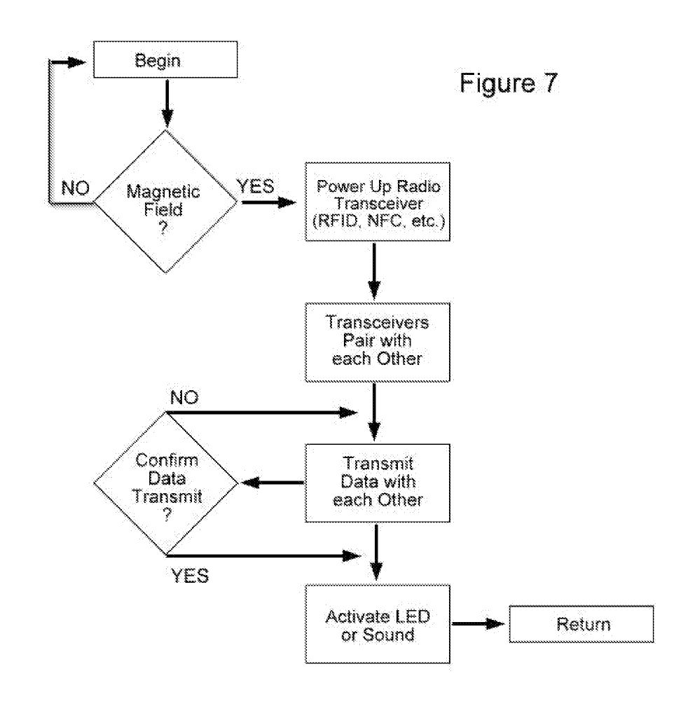

Referring to FIGS. 1-4, a connection bracelet 10 is shown, according to a first embodiment of the invention, including a band portion 12 and a body portion 14. Bracelet 10 may be manufactured as a low cost, one-time use, disposable bracelet, with a sealed one-time use battery, or a multi-use, more elegant device that includes either accessible replaceable batteries, or sealed rechargeable batteries. The rechargeable batteries, if provided, may be recharged inductively or directly by providing an appropriate charging connector. Either a rechargeable battery or a sealed disposable battery is preferred because it allows for continued use of the bracelet without disassembly. However, according to another embodiment, the bracelet may be designed to allow the user to replace the battery, either to allow replacement of a rechargeable battery that has reached the end of its service life, or to allow the use of non-rechargeable batteries. In such instance, bracelet 10 may include a small access cover (not shown) at an appropriate location.

For the low-cost versions, bracelet 10 is preferably made from a flexible one piece, integrally molded silicone rubber or flexible thermo plastic with a circuit module (20), a battery, and other components, depending on the particular embodiment, as detailed below, preferably all molded within body 12 during the molding process and sealed as a single unit, including the body 12 and band 14.

Alternatively, the above components may all be secured within a plastic or rubber body 12 first, using known injection molding techniques, and thereafter secured to or molded integrally with band 14 during manufacture or assembly. The above-mentioned low-cost version of bracelet 10 preferably includes a one-piece band 14 that is flexible so that it may easily slip on the wrist of the user and may accommodate many or all wrist sizes. Body 12 may be flexible as well, or rigid, or semi-rigid.

Other versions of bracelet 10 may include components that are similar to a conventional wrist watch, including a body 12 and a two-piece band 14 that may be adjustably secured to form a loop using a clasp. For more fashionable versions, bracelet 10 may be made using a combination of materials such as leather, plastic, metal, glass, woven textiles and rubber. The more fashionable version would resemble a jewelry piece with a long service life, included with either replaceable or rechargeable batteries.

Although certain materials and components of bracelet 10 are preferred, as described above, it is understood that the exact materials, dimensions and construction of bracelet 10 may vary without departing from the gist of the present invention. Also, bracelet 10 may be manufactured and assembled using any of a variety of processes, which are well known by those skilled in the art, such as injection molding and over-molding.

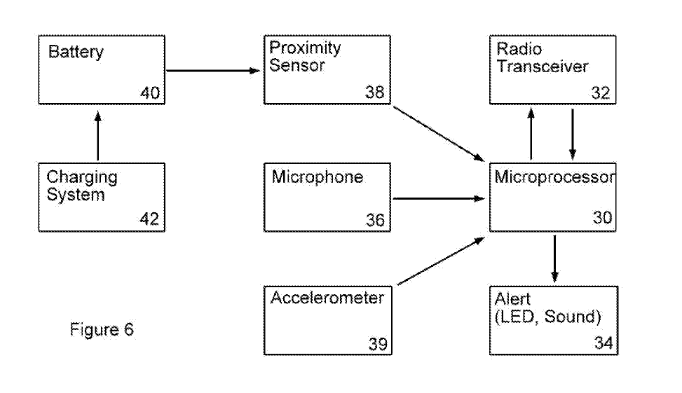

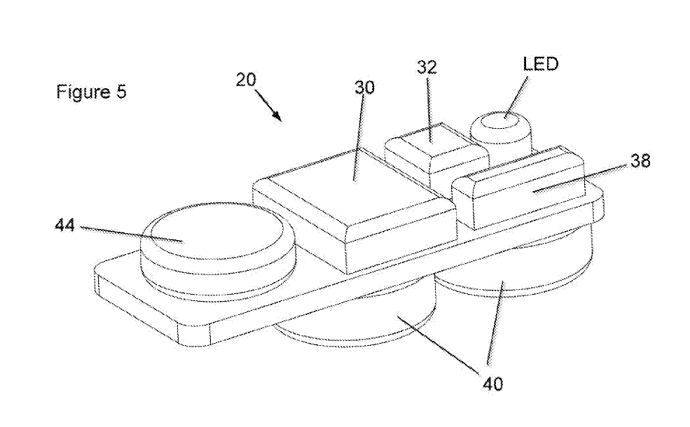

Referring to FIGS. 2 and 5, bracelet 10 is shown in exploded view as two halves, revealing circuit module 20. As shown in FIG. 5, and according to a first embodiment of the invention, circuit module 20 is essentially an active NFC circuit module 20 or a powered Bluetooth® transceiver circuit. An active NFC “tag” is a powered NFC that is capable to function as both a “master” transmitter of selected data and also a receiver of selected data. The transmission and receipt of data may happen simultaneously or sequentially. As is well known by those skilled in the art, NFC is very similar to RFID (Radio Frequency Identification), and Bluetooth® wireless transmission, except that the working distance of NFC is considerably closer—with a maximum working range of about 4 inches. This limitation is an advantage in certain applications, such as when it is important to only transmit data between specific known sources. Unfortunately, NFC transceivers typically requires a large receiving antenna which may be difficult to incorporate into a compact bracelet design. To overcome this deficiency, Bluetooth® LE (low energy) wireless transmission technology may be used to transmit data between adjacent bracelets, however, if Bluetooth® LE is used, it would preferably be calibrated to read only at very close range to increase target accuracy and effectiveness. owing to the subject application. For all applicable embodiments that use RF to transmit information between adjacent bracelets described herein, it is to be understood that any of many wireless transmission systems may be used, including Bluetooth®, Bluetooth® LE, NFC, RFID, and other RF protocols at other frequencies. Collectively, for reasons of clarity, these systems will all be hereinafter referred to as “Bluetooth®.”

As shown in FIG. 5, and according to this first embodiment of the invention, circuit module 20 includes a microprocessor 30, a radio transceiver 32 (which is preferably Bluetooth® LE (but may also be active NFC) and includes an appropriate antenna—not shown). Circuit module 20 further includes an LED/Sound alert driver circuit 34, a microphone 36, a proximity sensor 38, an accelerometer 39 and is powered by a battery 40.

As described above, depending on if battery 40 is the type that can be recharged, a charging system 42 may be used to charge onboard battery 40, as required. As understood by those skilled in the art, charging system 42 may be either inductive, in which case an appropriate charging coil would be provided within body 12 connected to battery 40, or through direct contact, in which case an appropriate charging connector socket would be provided for direct connection between onboard battery 40 and a remote charger (not shown).

Microprocessor 30 may be TI MSP430 microcontroller, available from Texas Instruments, Inc., of Dallas, Tex., but other microprocessors or other integrated circuit devices that are capable of performing the computational functions described here may be used. In fact, while certain electronic components may be described separately here for clarity and ease in description, as those of skill in the art will appreciate, bracelet 10 may use a “system on chip” (SoC) that includes a microcontroller, input-output capabilities, a radio transceiver, and other components in a single chip package. Furthermore, although not shown in the figures, it is to be understood that microprocessor 30 includes an onboard integral memory, for storing data to be transmitted and data to be received, along with other necessary operating instructions and data.

As mentioned above, proximity sensor 38 may be any of several types of sensors and communication systems, depending on the embodiment of this invention. According to a first embodiment, proximity sensor 38 is a magnetic field detector, such as a Hall effect sensor, or a Reed switch, or a magnetoresistive sensor. One such Hall effect sensor that could be used is an Omni-polar Switch Open Drain Hall Effect sensor, Part No. US1881, which is commercially available from The Digi-Key Corporation, located at Thief River Falls, Minn.

Alternatively, magnet field detector 38 may employ a passive reed switch, also available from the above-mentioned Digi-Key Corporation. Whichever device is used, both the Hall effect sensor and the Reed switch will detect magnet fields that are in close proximity. Since each bracelet 10 includes its own onboard magnet, the Reed switch is oriented with respect to the adjacent magnet in such a manner as to not be activated by the magnetic field of the local magnet, but activated by the magnetic field from another bracelet, when it is positioned at close proximity. As is known by those skilled in the art, Reed switches are directional and may be easily oriented to ignore nearby magnetic fields.

Similarly, in the case a Hall effect sensor is used in one bracelet 10 to detect the magnetic field of a magnet located in a nearby bracelet 10, the Hall effect sensor is calibrated to account for the local magnetic fields so that only newly introduced magnetic fields would be detected as a net positive and trigger microprocessor 30 to initiate data exchange between bracelets 10.

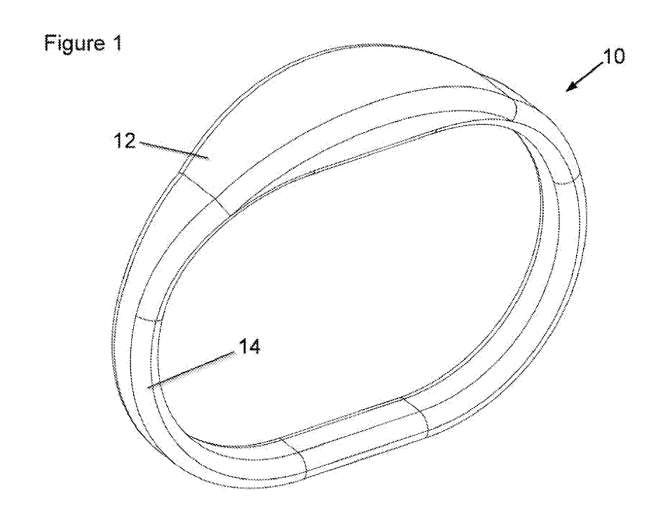

Regardless of the type of magnetic field sensor used as proximity sensor 38, and according to this embodiment of the invention, a magnet 44 is embedded within body 12 of bracelet 10 and preferably secured directly to circuit module 20, as shown in FIGS. 2 and 3. It is important to secure magnet 44 at a known location relative to the magnetic field sensor so that the above-described calibration may be used to accurate account for the local magnetic fields generated by the local magnet.

Battery 40 is used to power the electrical components of bracelet 10. According to this preferred first embodiment, battery 40 is effectively electrically disconnected from the other electronics, except proximity sensor 38 (in this case, a magnetic field sensor), which is essentially a switch. In this arrangement, microprocessor 30 and the other components would only be powered up if the magnetic field sensor detects a nearby magnetic field. When it does, the magnetic field sensor switches on, which effectively connects battery 40 to all electrical components, allowing data to be exchanged between bracelets 10. So, in this embodiment which uses a magnet to determine if two bracelets 10 are in close proximity with each other, data transmission is only sent when close magnetic fields are detected.

Magnet 44 is preferably a relatively powerful permanent rare-earth magnet, such as a neodymium type magnet. As mentioned above, magnet 44 is oriented in such a manner to prevent interference with the adjacent onboard magnetic field sensor. Although not preferred, magnet 44 may be an electromagnet that is powered by battery 40 at select times or continuously.

According to another embodiment, proximity sensor 38 is a capacitive sensor. In this embodiment, magnets 44 would not be required. A capacitive sensor detects any object that interferes with a controlled dielectric field. The dielectric field would be generated above the body 12 of each bracelet 10. The objects do not have to be metallic so the capacitive sensor will detect the presence of an immediately adjacent bracelet. Ideally, the capacitive sensor would be calibrated to detect the disruptive signature created when one bracelet 10 actually contacts another. The proximity sensor output would be read by microprocessor 30 and if a positive signal (meaning that the bracelets are next to each other) is detected, microprocessor 30 would instruct radio transceiver 32 to transmit contact information (the user's ID or other code) to the adjacent bracelet.

According to another embodiment of this invention, body 12 of bracelet 10 includes a conductive contact plate that is accessible from outside the bracelet body 12. With this arrangement, two users “connect” with each other when the two respective conductive plates of each bracelet contacts each other. Each plate is electrically connected to each respective microprocessor 30, so when the two plates are touched (even for a second), the microprocessor 30 can initiate data exchange using Bluetooth®. The plates may also include magnetic attraction components (magnets) to encourage a longer connection of plates. The longer undisturbed connection could allow for data to Title: Socially-Enabled, Body Worn Communication Device and Method for Use Page 10 flow directly between the two microprocessors, without using wireless transmission protocols.

According to yet another embodiment of the present invention, each bracelet 10 includes a microphone 36, as shown in FIG. 5) which is connected to microprocessor 30, as in earlier embodiments described above. In this case, each user simply places their bracelets 30 adjacent to each other and then announces a prescribed signature phrase or password to initiate data transmission. The voiced password would be “heard” by microprocessor 30, through microphone 36 and compared to stored passwords and verified. If there is a match, microprocessor 30 would initiate transmission of contact information using Bluetooth®.

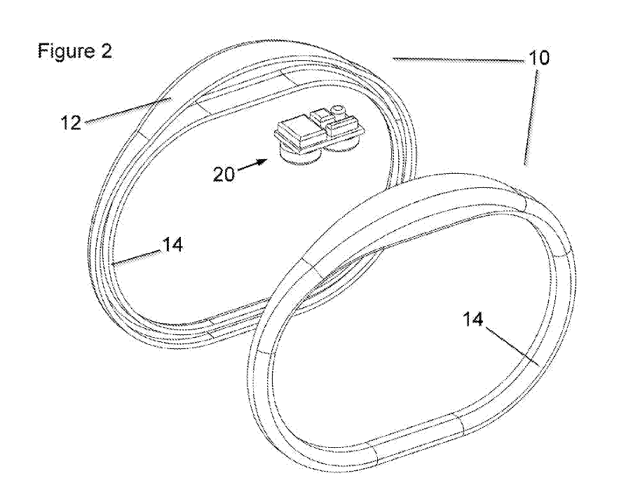

According to yet another embodiment of the present invention, each bracelet 10 includes an infrared emitter and receiver pair (not shown) so that when two bracelets are adjacent to each other (and aligned), the IR couplers of each bracelet 10 can communicate with each other and exchange contact information to each other. The “coupler” may also be visible light, instead of IR. The communication action is conveyed by arrows 46 in FIG. 4.

The actual data being transmitted is preferably an ID code that may be used to link the wearer to his or her account, but only by a protected server, controlled and maintained by a trusted third party, such as the ticket issuer of a concert performance or the stadium of a baseball game, or an independent, but trusted company.

According to another embodiment, each bracelet includes accelerometer 39, as shown in FIG. 5 and microphone 36 and associated control circuitry (not shown). In this embodiment, two users will initiate exchange of contact information by acting out a pre-established gesture, such as a ‘high-five” slap, and simultaneously shout out a predetermined selected audible word, phrase or sound (such as: “alright” or “great”). As in above-described previous embodiments, microprocessor 30 will receive the audible signal from microphone 36 and the gesture signal from accelerometer 39 and verify that the signals match stored versions. Once confirmed, the communication circuit of each bracelet will transmit and receive contact information. Both these embodiments and others are described in greater detail below.

According to yet another embodiment of the invention, each bracelet 10 includes magnet 44 and when two bracelets are adjacent to each other sufficiently that magnets 44 attract and contact, the acceleration (and sudden deceleration) signature of magnets 44 is detected and used to initiate data exchange.

Alternatively, magnet 44 of one bracelet 10 connects with magnet 44 of an adjacent bracelet 10, but in this embodiment, there is no proximity sensor 38 and no microphone 36 and no accelerometer 39, as described above in earlier embodiments. In this embodiment, the magnets are used to ensure positive mechanical connection between the bracelets. The snap sound and resulting attraction force created when two magnets “connect” will provide a satisfying stimulus to the two users that are meeting. The snap sound signifies “we are connected” and becomes a social indicator of closure to a happy meeting. The snap sound compliments the conventional shaking of hands. It also allows time for the RF transceivers (e.g., Bluetooth®, RFID, NFC, etc.) to pair and exchange data between bracelets. In this arrangement, Bluetooth transmission is programmed to pair and transmit data whenever it reads another Bluetooth enabled device within a prescribed range, which is preferably very close (less than an inch).

According to a variation of this embodiment, the connecting magnets will be detected by above-described magnetic field sensors, but instead of controlling the transmission of data, as before, the detection of the magnets will simply start a timer within each circuit module of each bracelet. A timer is typically incorporated within any microprocessor chip 30 and will count a predetermined time period (between 3-5 seconds). After the time period has elapsed, microprocessor 30 will instruct onboard alert driver 34 to light up (LED) or sound (piezo speaker) to indicate that data has exchanged. In this embodiment, the time period is independent of any confirmation of data exchange. It is just meant to keep the bracelets 10 connected long enough to ensure that the Bluetooth® transceivers have sufficient time to make the connection and exchange data.

According to yet another embodiment, the Bluetooth® RF wireless transmission protocol does not have to be tuned for close activation only, as suggested in above-described embodiments, and can continually read within a large range. To ensure that Bluetooth® only exchanges data between the subject bracelets that are touching, or adjacent to each other only, microprocessor 30 in each adjacent bracelet 30 creates a timestamp to record the exact moment each proximity sensor 38 first detected the other adjacent bracelet 10 and shares this information with the other bracelet. Bluetooth® will effectively use this information to verify which two bracelets are to exchange data. Received information could only be accepted by another bracelet if the sending wristband logged a sensor input at the same time as the receiving wristband.

According to yet another embodiment of the invention, bracelet 10 only includes a magnet with no onboard electronics at all. The bracelets in this embodiment will only snap together when they are adjacent to each other. The snap sound and attraction force, in this case, is just meant to be fun, conveying a satisfying closure to the meeting of a new friend. In this embodiment no data will be exchanged.

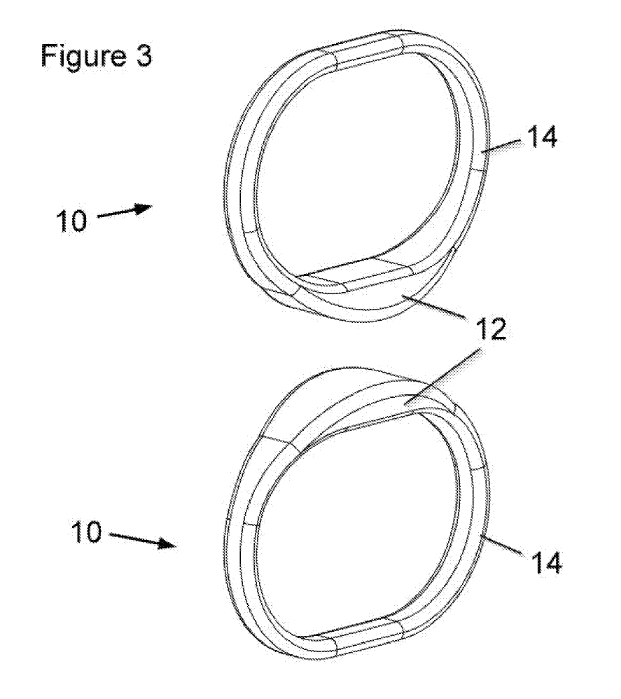

In operation, referring to FIG. 7 bracelet 10 reads for a magnetic field. If one is detected, the components of circuit module 20 are powered up and the transceivers 32 of both bracelets begin to pair with each other, preferably using Bluetooth® wireless. Following Bluetooth protocol, the transceivers transmit data with each other and confirm that the data has been received by each. If yes, microprocessor 30 instructs alert driver circuit 34 to either illuminate an LED or generate a sound (or a vibration) to indicate that contact information has been successfully exchanged.

In use, by way of example, at a concert venue, a first female user either already owns bracelet 10, or is sent one after in the mail when she purchases tickets online. The ID code associated with bracelet 10 will automatically be linked to her account that she set up when purchasing the tickets.

At the event, her bracelet 10 is her electronic ticket to enter. She can also use her bracelet 10 to purchase food and other items simply by positioning bracelet 10 adjacent to a reader that would be located nearby. Her ID (the bracelet's ID) will be transmitted by Bluetooth® to the reader and then to the venue's server for later billing, similar to a credit card purchase.

If she meets someone (a second user—a male), and wants to keep in touch after the event, the two simply connect their bracelets 10 so that magnets 44 in each snap together, as described above, and their respective ID's transmit to the memory of each other's circuit module 20 using Bluetooth® protocol (or NFC, or RFID, etc.). She later meets several other people at the event. She returns home that night with several IDs stored in her bracelet 10.

She now uses the Bluetooth® reading feature of her smartphone to download the stored IDs into her phone. The ID information will include an autolink to a website (or to an app on her smart phone) and the downloaded IDs will populate in a column on a webpage (or in the app on her smart phone). Some information associated with the ID may be provided, such as a picture, a first name, or a screen name to help her remember each person she met.

If she decides to connect with any of the people on the list, she simply sends a friend-request via any number of social media networks or a new one. Based on the ID information, the venue's server will send her request to the particular user and then send any acceptance back to her, at which point she and her friends will now be connected and they can continue to interact. The friend-request may be declined, at which point no further connection can be made.

Alternatively, according to a variation, once she connects her bracelet to another bracelet at the concert, for example, this functions as a friend-request from each party to the other. Both parties must then both accept the request for the connection to be confirmed and for the parties to continue to interact over the social network and potentially have access to additional contact information.

What is claimed is:

1. A method for exchanging electronic data between two people using wearable electronic devices, each device having control circuitry and a magnet, said method comprising:
detecting at a first device, a second device located in proximity thereto;
allowing magnets of each device to magnetically engage with each other;
selecting, by said first device, first data to be sent to said second device; and
sending, by said first device, the selected first data to said second device.

2. The method of claim 1 further comprising:
subsequently to detecting said second device in proximity to said first device, and while said first device remains in proximity to said second device, receiving, by said first device, second data from said second device.

3. The method of claim 1 wherein said first data includes an identification code that conveys contact information of the person wearing said first device.

4. The method of claim 2 wherein said second data includes an identification code that conveys contact information of the person wearing said second device.

5. The method of claim 1, after the step of sending the first data to said second device, further comprising the step of:
storing, by said second device, said received first data in electronic memory.

6. The method of claim 2, after the step of sending said second data to said first device, further comprising the step of:
storing, by said first device, said received second data in electronic memory.

7. The method of claim 1, wherein each of said devices further includes an accelerometer for measuring acceleration rates, after the step of allowing magnets of each device to magnetically engage with each other, said method further comprises the step of:
detecting the acceleration of said magnet engagement and sending said first data in response to said acceleration detection.

8. The method of claim 2, wherein each of said devices further includes an accelerometer for measuring acceleration rates, after the step of allowing magnets of each device to magnetically engage with each other, said method further comprises the step of:
detecting the acceleration of said magnet engagement and sending said second data in response to said acceleration detection.

9. A wearable electronic device comprising:
a wireless communication interface operable to communicate with another electronic device;
a memory storage configured to store received data; and
a magnet sized and shaped to magnetically engage with another magnet of a second wearable electronic device located in close proximity, causing the two devices to accelerate quickly towards each other until contact is made.

10. The wearable electronic device of claim 9, further comprising an accelerometer operable to detect an acceleration signature during movement of the wearable electronic device.

11. The wearable electronic device of claim 10, wherein said movement of said devices by the attraction of said magnets creates a unique acceleration signature which is detected by said accelerometer.

12. The wearable electronic device of claim 11, wherein said acceleration signature of said movement is used to transmit data between engaged devices.

13. The wearable electronic device of claim 9, wherein the wearable electronic device is a bracelet and is wearable on a user's wrist.

14. A method for exchanging electronic data between two people using wearable electronic devices, each device having control circuitry and a magnet, said method comprising:
detecting at a first device, a second device located in proximity thereto;
detecting, by said first device, a magnetic field of said magnet of said second device, thereby indicating that said first and second devices are in close proximity to each other; and
sending, by said first device, a first data to said second device.

15. The method of claim 14, further comprising:
subsequently to detecting by said first device, said magnetic field of said second device and while said first device remains in proximity to said second device, receiving, by said first device, a second data from said second device.

16. The method of claim 14, wherein said first data includes an identification code that conveys contact information of the person wearing said first device.

17. The method of claim 15, wherein said second data includes an identification code that conveys contact information of the person wearing said second device.

18. The method of claim 14, after the step of sending the first data to said second device, further comprising the step of:
storing, by said second device, received first data in electronic memory.

19. The method of claim 15, after the step of sending said second data to said first device, further comprising the step of:
storing, by said first device, received second data in electronic memory.

20. A method for exchanging electronic data between two people using wearable electronic devices, each device having control circuitry, an accelerometer and a microphone, said method comprising:
detecting by said microphone at a first device, an audio signature;
matching at said first device said received audio signature with a stored audio signature;
detecting by said accelerometer at said first device, a movement signature;
matching said received movement signature with a stored movement signature;
sending, by said first device, a first data to said second device in response to determination of a signature and a movement match.

21. The method of claim 20, wherein said both matching steps occur simultaneously.
